(19) United States
(12) Patent Application Publication
(10) Pub. No.: US 2026/0201286 A1
(43) Pub. Date: Jul. 16, 2026

(54) METHOD FOR EXTRACTING BIOACTIVE COMPOUNDS FROM ETHANOL BREWER'S STILLAGE

(71) Applicant: IMMORTAZYME COMPANY LTD., Calgary (CA)

(72) Inventor: VINCENT YACYSHYN, Calgary (CA)

(21) Appl. No.: 19/134,239

(22) PCT Filed: Nov. 29, 2023
(86) PCT No.: PCT/CA2023/051596

§ 371 Date: May 30, 2025

Related U.S. Application Data
(60) Provisional application No. 63/429,709, filed on Dec. 2, 2022.

(51) Int. Cl. C12F 3/00; B01D 3/00; B01D 21/26

(52) U.S. Cl. CPC C12F 3/00; B01D 3/001; B01D 21/262

(57) ABSTRACT

A method of extracting bioactive compounds suitable for human and animal consumption from ethanol brewer's stillage. Stillage comprising spent grains suspended in water is provided from an ethanol plant. A lyophilized enzyme is added to the stillage. Ethanol is added to the stillage to form a mixture of ethanol and stillage. The mixture of ethanol and stillage is mixed and ethanol is extracted from the mixture to form a solution of bioactive compounds dissolved in extracted ethanol and spent grains containing the lyophilized enzyme. The bioactive compounds from the extracted ethanol are then separated by distillation or evaporation of the ethanol.

### FIELD OF THE INVENTION

The invention relates to a method of extracting bioactive compounds from ethanol brewers' stillage.

Although microscale methods have been used to increase the extraction power and batch capacity and improve sample quality, solvent amounts and extraction time compared to conventional extraction methods for various bio active compounds including polyphenols, commercial scale extraction has proven challenging. Conventional extraction of secondary metabolites is time-consuming and generates substantial amount of solvent waste. Zavala-Lopez. Plant Methods (2017) 13:81. DOI 10.1 186/s13007-017-0235-x.

There are numerous advantages and limitations of brewers spent grain extraction processes and the production of agricultural byproducts can provide new value added products from the brewers spent grain. Extraction methods have been applied and new techniques are needed for cost effective extraction. Bonifacio-Lopes et al. Crit Rev. Food Sci Nutr. 2020; 60(16); 2730-2741.

It has been shown that byproducts of flaxseed oil extraction consisted of protein, mucilage, and polyphenol compounds. Extraction methods of the phenolic acids include dioxan/ethanol, water/acetone, water/methanol, and water/ethanol in addition to enzymatic hydrolysis. The addition of carbohydratases and/or proteases allowed for optimal results for removal of the flaxseed byproducts compared to conventional non enzymatic extraction. Dias Ribeiro et al. Hindawi Publishing Corporation. ISRN Biotechnology, Vol. 2013, Article ID 521067, 6 pages. Similarly, the industrial processing of raspberry pomace resulted in the lipophylic and hydrophilic phytochemicals. Various combinations of carbohydratases and proteases improved the extraction of these compounds. Saad et al. Journal of Food Science. 21 May 2019.10.1111/1750-3841.14625.

The kinetics of polyphenyl extraction from brewers spent grain using a batch system in the evaluation of antioxidant capacity of these extracts over time were evaluated to determine the optimal conditions of liquid/solid and ethanol/water solvent Extractions were also studied with ultrasound assistance and this demonstrated the highest extraction rate in yield is well as the shortest extraction time. Patricelli's model proved the most suitable for describing extraction kinetics. Carciochi et al. Antioxidants 2018, 7, 45; doi:10.3390/antiox7040045.

Maceration has also showed the highest phenolic yield when applied to microwave extraction of brewer's spent grains. In this study, microwave assisted separation showed the phenolic compounds were simplified to monomers. Stefanello et al. Food Chemistry 239(2018) 385-401.

Polyphenols are secondary plant metabolites and represent a large and diverse group of substances abundantly present in fruits herbs and vegetables. Extraction methods including super critical fluid extraction highlight a promising ecofriendly alternative to extraction of polyphenols. The protective role of polyphenols against reactive oxygen, nitrogen species, UV light, plant pathogens, parasites, and preditors emphasizes their commercial value. The main problem in extracting these compounds is their low bioavailability rapid metabolism. Mojzer et al. Molecules. 2016.21,901, doi:10.3390/molecules21070901.

The value of polyphenols with regards to their antibacterial activity is well known. This activity depends on the lipophilicity and the electronic charge properties of the polyphenols. The antibacterial activity of most polyphenols depends on interactions between the polyphenols and bacterial cells. Bouarab-Chobane et al. Frontiers in Microbiology. 18 Apr. 2019, doi 10,3389/fmicb.2019.00829.

Phytochemicals in corn bran and in corn bran fiber vary. The quantity of phytosterols in current corn brain in fiber is approximately 1.0-11.3 mg per 100 g of fiber. Dapcevic-Hadnadev et al. in Sustainable Recovery and Reutilization of Cereal Processing By-Products.2018.

Phenolic compounds are parts of secondary metabolites found in many plant species that can be glycosides or aglycones, matrix free bound compounds, and polymerized or monomeric structures. The extraction process is challenging there are several conventional and unconventional techniques for extraction. Conventional extraction methods are mostly designed by utilizing larger volume of extraction solvents and manual procedures that are mostly dependent upon the feedstock. These methods include solid-liquid extraction or soxhlet extraction, liquid-liquid extraction and maceration. These conventional methods suffer many drawbacks. To overcome these challenges, additional methods include pressurized liquid extraction, subcritical water extraction, super critical fluid extraction, microwave assisted extraction, solid phase extraction, ultrasound extraction, hydrostatic pressure extraction, solid supported liquid-liquid extraction, matrix solid phase dispersion, and counter current chromatography. Additional improvements on conventional techniques include automation, enhanced selectivity, and reduce consumption of extraction solvents. Alara. Current Research in Food Science. 4(2021)22-214.

Brewers' spent grain is an abundant by-product rich in various bio active compounds. Extraction methods that have been attempted include super critical carbon dioxide, autohydrolysis, alkaline hydrolysis, solvent extraction, ultrasound assisted extraction, dilute acid hydrolysis, enzymatic hydrolysis, and microwave assisted extraction. There are advantages and limitations to each of these processes depending on the compounds to be harvested from the brewers spent grain. Bonifacio-Lopes. Critical Reviews in Food Science and Nutrition. 2020, Vol. 60, No. 16, 2730-2741.

The demand for polyphenols that are present in small amounts in many fruits vegetables and functional food is growing for many reasons. Extracting polyphenols is challenging because extraction techniques should not alter food quality Conventional techniques include Percolation, decoction, heat reflux extraction, Soxhlet extraction, and maceration. Advanced technologies for extraction include: ultrasound assisted extraction, microwave assisted extraction, super critical fluid extraction, high-voltage electrical discharge, pulse electric field extraction, and enzyme assisted extraction. Advanced techniques are 32 to 36% more efficient with approximately 15 times less energy consumption and produce higher quality extracts. Membrane separation and encapsulation are promising future techniques. Process parameters of significance include solvent type, solid and solvent ratio, temperature, and particle size. Sridhar et al. Environmental Chemistry Letters. (2021) 19:3400-3443.

The known methods for extraction in isolation of natural products has been reviewed in an article published by Zhang et al. Chin Med.

(2018)13:20.doi.org/10.1186/s13020-018-0177-x. The extraction methods that have been identified include maceration, percolation, decoction, reflux extraction, Soxhlet extraction, pressurized liquid extraction, supercritical fluid extraction, ultrasound assisted extraction, microwave assisted extraction, pulsed electric field extraction, enzyme assisted extraction, and hydro distillation and steam distillation extraction.

Fat soluble nutraceuticals have been extracted from rice bran using subcritical di-methyl ether extraction. The combination of transesterification and subcritical di-methyl ether extraction was felt to be a simple 2 step method to extract and purify policosanol. Wongwaiwech et al. Nature Research. Scientific Reports.(2020) 10:21007.doi.org/10.1038/s41598-020-78011-z.

The effects of 3 factors: including pressure, temperature, and ethanol concentration were maximized to extract phenolic compounds from brewers spent grain with the use of supercritical carbon dioxide. A pressure of 35 mPA, 40° C. temperature, and 60% ethanol was felt to be optimum. The limitations of super critical carbon dioxide extraction were evident. Spinelli et al. J. of Supercritical Fluids 107(2016)69-74.

The purification of polyphenols from distiller's grains using macroporous resin has been evaluated. Phenolic content was analyzed by ultra performance liquid chromatography and tandem mass spectroscopy. Optimal conditions were noted with D 101 resin with a dosage of 3 g, 4 hours adsorption, and 3 hours desorption in an 60% ethanol eluent. A purification rate of 51% was noted. Polyphenolic compounds obtained included: epicatechin, ferulic acid, hydroxybenzoic acid, caffeic acid, syringic acid, quercetin, vanillic acid, and gallic acid. Wang et al. Molecules 2019. Apr. 2; 24(7); 1284.

The removal of phenol from aqueous solution has also being evaluated with nonfunctionalized hyper cross linked polymer and ion exchange resins. The extent of phenol adsorption is affected by pH. The desorption of the nonfunctionalized resin was achieved by 50% methanol to water with recovery of close to 90%. Caetano et al. Journal of Colloid and Interface Science 338(2009) 402-409.

Two effective ion exchange chromatography processes were studied to determine the separation and recovery of monosaccharides, organic acids, and phenolic compounds from two kinds of hydrothermal liquefaction hydrolysates. Anion and cation exchange resins were used in chromatography separation with recovery of 70-97%. Chen et al. Separation and Purification Technology. 172(2017)100-106.

U.S. Pat. No. 7,820,419B2 describes a process for producing a fermentation product within amylase and protease. This patent details use of protease to degrade proteins during the processing and production of fermentation products such as ethanol from starch containing material.

U.S. Pat. No. 9,057,087B2 is a method of producing a fermentation product comprising liquifying a starch containing material to dextrins in the presence of asparaginase to reduce Maillard products.

U.S. Pat. No. 7,820,419B2 relates to a process for producing a fermentation product from starch containing material. This material is treated with amylase and protease in the presence of a fermenting organism. The protease was used to enhance protein degradation and subsequently enhance oil production.

Canadian Patent 2815430C teaches compositions and methods for the production of fermentable sugars using genetically modified fungal organisms. This patent provides enzymes that find use in enhancing hydrolysis of cellulosic material to fermentable sugars. The patent is silent on the extraction of bio active compounds from this feedstock stock.

Russian Patent 2771261C2 describes a method for producing fermentation products from a starch containing material. The proteases used in this patent enhanced the breakdown of mash for subsequent oilseed production.

Chinese Patent 101138686A describes a method for extracting active ingredients from natural products and uses thereof. This patent teaches solid phase extraction of natural products including solid phase material as well as gas liquid solid phase processes and optimization of these processes but is silent with regards to distillers grains and subsequent products.

WO 2015164336A2 and WO 2016089816A1 are inventions that provide novel improved methods that allowed effective capture of valuable active ingredients in biomass. These patents teach extraction of 1 or more active ingredients from biomass using multiple solvents, alkaline aqueous extraction, evaporation and subsequent enzymatic hydrolysis into separate nucleic acids and biologic compounds.

Russian Patent 2402242C2 describes the method for complex synthesis of a biologically active substances from alcohol wastes. This patent describes the separation of vinasse into liquid and solid fractions, filter in the liquid fraction, evaporating it, treating the concentrate with various organic solvents, filtering the precipitate, washing and drying and grinding subsequent precipitates, and then macerating this solution with ammonium oxalate and subsequently treating the concentrate with alcohol.

### SUMMARY OF THE INVENTION

The present invention provides a safe, cost-effective method that is scalable and methodologically feasible in grain processing facilities. The separation method, in addition to being methodologically feasible, produces a unique combination of products that include bioactive compounds such as polyphenols. The unique characteristics of the final product meet criteria for various end users in a here to for not described method. The process is simple and able to produce adequate quantities of bioactive compounds suitable for human or animal consumption in a methodologically robust manner.

Objectives of the invention and other objectives can be obtained by a method of extracting bioactive compounds from ethanol brewers' stillage comprising:
providing stillage from an ethanol plant, the stillage comprising spent grains suspended in water;
adding a lyophilized enzyme to the stillage;
adding ethanol to the stillage to form a mixture of ethanol and stillage;
mixing the mixture of ethanol and stillage;
extracting the ethanol from the mixture of ethanol and stillage to form a solution of bioactive compounds dissolved in extracted ethanol and spent grains containing the lyophilized enzyme; and
separating the bioactive compounds from the extracted ethanol by distillation or evaporation of the ethanol.

### BRIEF DESCRIPTION OF THE DRAWINGS

FIG. 1 illustrates an ethanol brewing plant modified to include the present method of obtaining bioactive compounds from the ethanol stillage.

FIG. 2 illustrates a GO/MS spectrogram of the extract.

FIG. 3 illustrates a GO/MS spectrogram of the extract using no enzyme.

FIG. 4 illustrates a GO/MS spectrogram of the extract using a lyophilized enzyme

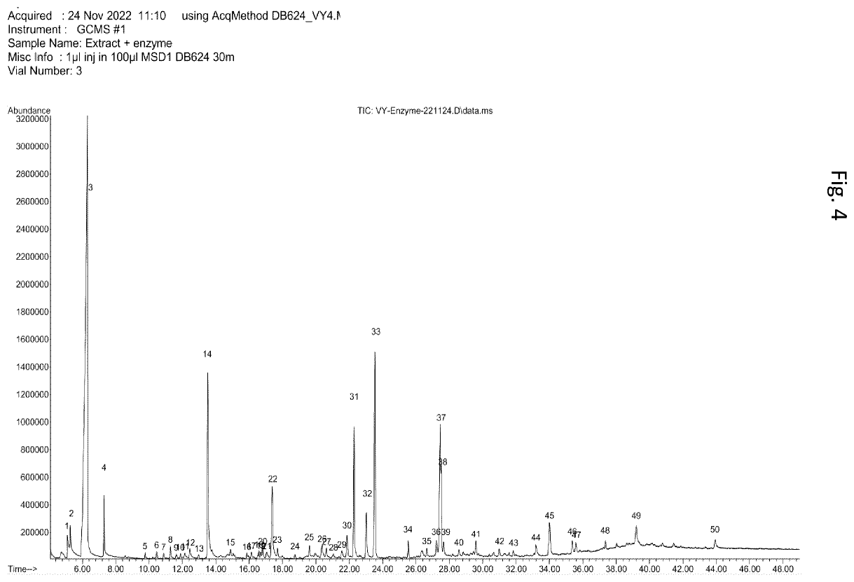

### DETAILED DESCRIPTION OF THE INVENTION

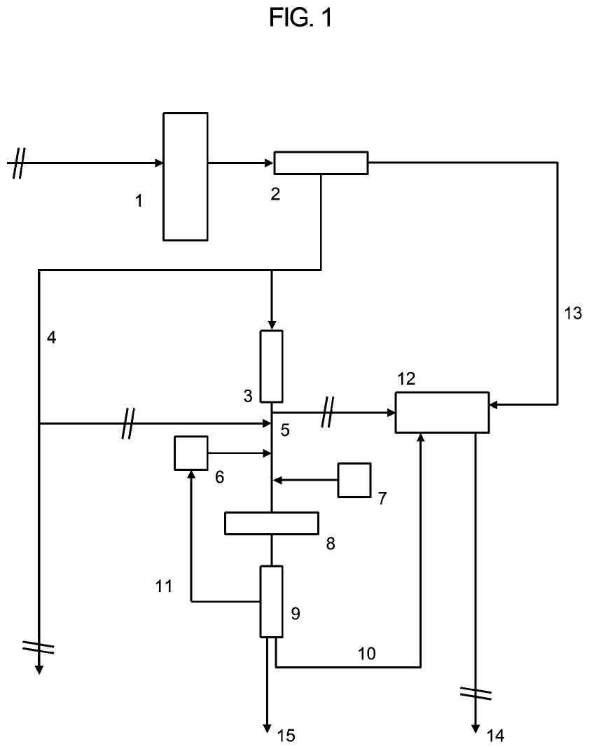

FIG. 1 illustrates a modified bioreactor (ethanol plant). In the ethanol plant grains are fermented to form a mixture of ethanol, water and spent grains. Fermentation products leave the Beer Well and pass through the stripping column 1 where ethanol and distiller's grains are separated to form stillage. The distiller's grains pass through the first centrifuge 2 where wet cake and thin stillage are separated. The thin stillage passes through a syrup evaporator 3 and a portion of the flow proceeds as thin stillage 4 and the syrup 5 may be added to the wet cake 13 and placed into the dryer 12. The product of this stream is distillers' dry grains with solubles 14.

The unique and novel process stream, takes the syrup from the syrup evaporator 3 and instead of placing the syrup into the dryer 12, the syrup is placed into a new process with the addition of ethanol 6 and lyophilized enzyme 7 to be mixed and separated in a second centrifuge 8. The liquid phase proceeds to an evaporator 9 and syrup 10 from the evaporator and solids from the second centrifuge 8 are recycled to the dryer 12. The ethanol 11 can recycled back into the ethanol stream for the new separation process. The bioactive compounds 15 are the precipitate or solids from the evaporator 9. Variable flow is indicated as “//” throughout the process.

The grain me be any combination of corn, wheat, or barley or other grains or combination thereof. This material is the feedstock for subsequent processing in a biorefinery. Examples of suitable sizes include 8 sieve (2.4 mm) to 100 (0.1 mm) sieve size grain, preferably 60 to 80 sieve grain.

A preferred method is the creation of thin stillage with contents including distiller's grains. The distiller's grains are created by heating the previously ground grain to approximately 60 to 70° centigrade (although the temperature may be higher or lower). The subsequent mash is allowed to rest. The mash and effluent may be treated with any combination of lyophilized enzymes including amylase, glucoamylase, or proteases. Non-lyophilized enzymes should be avoided.

As this thin stillage flows through the biorefinery, the stream or portion of the stream of thin stillage and effluent may be subject to a wash with 80-99% ethanol. The thin stillage and effluent is washed with a minimum amount of ethanol in accordance with the flow rate of stillage and effluent through the biorefinery. The initial mixture of ethanol and thin stillage and effluent is centrifuged at 500 rpm for a retention time of 5 to 25 minutes, preferably 15 minutes.

Proteases may be added to the ethanol wash to enhance the efficacy of bioactive compound extraction.

After centrifugation at 500 rpm, the mixture in centrifuged at 1,000 to 10,000 rpm, preferably 10,000 rpm, for 5 to 15 minutes, preferably 10 minutes.

The thin stillage and effluent is subsequently washed with water and processed downstream into further distiller's grains products. The water washing is necessary to avoid potential combustion after ethanol washing.

The ethanol wash is evaporated preferably in a nonflammable inert gas but not limited to that is contained within a chamber (such as nitrogen) and the ethanol is recycled for additional treatment and washing of the feedstock. The concentration of ethanol used to wash the initial feedstock is minimized independent on the flow rate of thin stillage through the processing apparatus.

The precipitant from the evaporation of the ethanol is collected and no further purification is required. This precipitant can include any number of bioactive compounds suitable for human or animal consumption including but not limited to polyphenols (Cinnamic acid derivatives—ferulic acid and p-coumaric acid, Benzoic acid derivatives—caffeic acid, Anthocyanins—cyanidin-3-glucoside and delphinidin-3-glucoside, Flavones—tricin, and Lignans—secoisolariciresinol diglycoside). These compounds may also include: formic acid, propanol, propanone, propylene glycol, butanediol, furfural, furanmethanol, lactic acid, dihydroxyacetone, ethanol, oxirane, furancarboxylic acid, thiazole, maltol, furanone, pyranone, diglycerol, pentanoic acid, methylbutanoic anhydride, hydroxymethylfurfufral, benzenediol, succinic acid, tetraoxacyclododecanone, methylbutanoate, or benzoic acid.

The surprising and unique aspect of the present process is the simplicity, the use of lyophilized enzymes and avoidance of non-lyophilized enzymes. The ability to harvest a combination of bioactive compounds without over purifying them allows for a robust mechanical method of screening and extracting a portion of the bioactive compounds including polyphenols from the thin stillage. This unique process allows for a cost effective method of extracting bioactive compounds from thin stillage.

### EXAMPLES

### Example 1

310 g of number 60 sieve (0.250 mm) mixture of ⅓ corn, ⅓ barley, ⅓ wheat was added to 1.2 liters of water and heated to 70° Celsius (C). The mixture was allowed to rest for 90 minutes and the liquid decanted from the resultant distiller's grains.

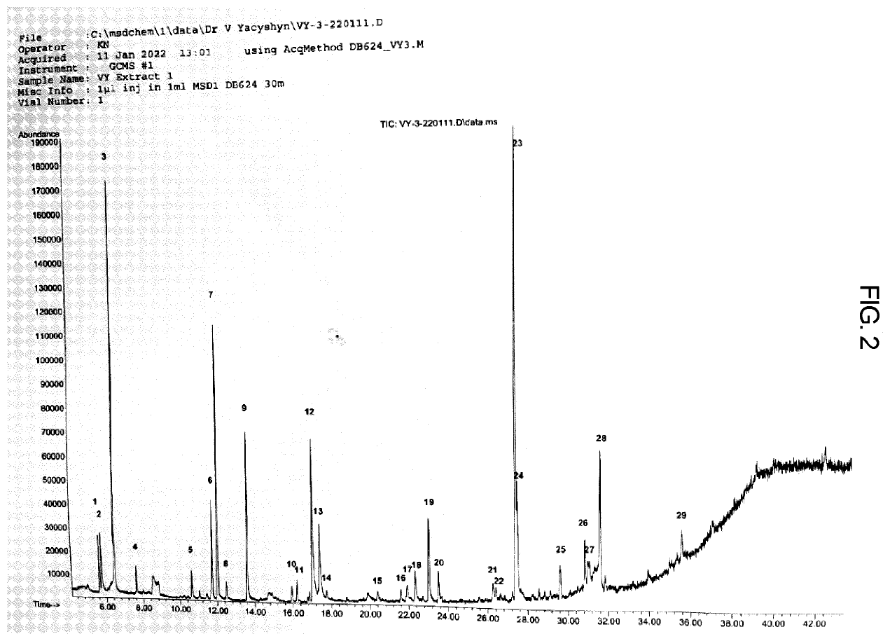

One (1.0) grams of the resultant distiller's grains were added to 10 mL of 80% ethanol. The sample was incubated at room temperature in a centrifuge at 500 rpm for 15 minutes and then centrifuged at 10,000 rpm for 10 minutes at room temperature. The ethanol was evaporated under a stream of nitrogen to 1 mL and 1 microL of the liquid phase was injected for gas chromatography/mass spectroscopy. NIST (United States National Measurement Institute) mass spectral library search was used to identify the peak of the resultant mass spectrum and compared to known standards. The 25^{th} peak identified included phenolic compounds. See Table 1 and FIG. 2 GC/MS spectrogram.

TABLE 1

| Peak # | NIST Library Top Match | Quality |
|---|---|---|
| 1 | Formic acid | 56 |
| 2 | Acetaldehyde, hydroxy- | 49 |
| 3 | Acetic acid | 91 |
| 4 | 2-Propanone, 1-hydroxy- | 80 |
| 5 | 2-Propenoic acid, 2-hydroxyethyl ester | 83 |
| 6 | 3-Penten-2-one, 4-methyl- | 87 |
| 7 | 2-Propanone, 1-hydroxy- | 42 |
| 8 | Propanoic acid, 2-oxo-, methyl ester | 9 |
| 9 | Butanal, 3-hydroxy- | 32 |
| 10 | 2,3-Butanediol | 90 |
| 11 | Propanenitrile, 3-(1-methylethoxy)- | 78 |
| 12 | Furfural | 87 |
| 13 | Silane, ethyldimethyl- | 88 |
| 14 | 2-Furanmethanol | 95 |
| 15 | 4-Cyclopentene-1,3-dione | 64 |
| 16 | 1,2-Cyclopentanedione | 83 |
| 17 | 2-Cyclohexen-1-ol | 59 |
| 18 | 2-Furanmethanol, 5-methyl- | 90 |
| 19 | Butyrolactone | 80 |
| 20 | 2(5H)-Furanone | 87 |
| 21 | Isomaltol | 59 |
| 22 | Dihydroxyacetone | 74 |
| 23 | Pentanoic acid, 2,2-dimethyl-, ethenyl ester | 50 |
| 24 | 2H-Pyran-2,6(3H)-dione | 64 |
| 25 | Benzeneacetaldehyde | 87 |
| 26 | 2-Hydroxy-gamma-butyrolactone | 47 |
| 27 | Furaneol | 81 |
| 28 | Hydrouracil, 1-methyl- | 59 |
| 29 | Furyl hydroxymethyl ketone | 87 |
| 30 | 5-Hydroxymethyldihydrofuran-2-one | 45 |
| 31 | Maltol | 91 |
| 32 | 1,3-Propanediamine, N-methyl- | 72 |
| 33 | 4H-Pyran-4-one, 2,3-dihydro-3,5-dihydroxy-6- | 95 |
| | methyl- | |
| 34 | 2-Imidazolidinethione | 43 |
| 35 | 1,2-Ethanediol, 1-(2-furanyl)- | 42 |
| 36 | (S)-5-Hydroxymethyl-2[5H]-furanone | 68 |
| 37 | 2(3H)-Furanone, dihydro-4-hydroxy- | 50 |
| 38 | 5-Hydroxymethylfurfural | 84 |
| 39 | Catechol | 81 |
| 40 | Butyl 2,5,8,11,14,17,20,23,26-nonaoxaoctacosan- | 42 |
| | 28-oate | |
| 41 | Hydrazine, 1,1-diethyl-2-(1-methylpropyl)- | 53 |
| 42 | Ethanamine, 2-methoxy- | 43 |
| 43 | Ethanamine, 2-methoxy- | 53 |
| 44 | 1-(O-Hydroxyphenyl)-2-(methylamino)propane | 64 |
| 45 | 1,3-Propanediol, 2-ethyl-2-(hydroxymethyl)- | 37 |
| 46 | 1-[3-Hydroxypropyl]-aziridine | 43 |
| 47 | .beta.-D-Glucopyranose, 1,6-anhydro- | 49 |
| | Pyrrolo[2,3-d]pyrimidin-4-one,3-amino-7-[.beta.-d- | 48 |
| 48 | ribofurasonyl]- | |
| 49 | 3-Deoxy-d-mannoic lactone | 27 |
| 50 | benzamide, N-[4-(heptyloxy)phenyl]-2,6-dihydroxy- | 35 |

### Example 2

310 g of number 60 sieve (0.250 mm) mixture of ⅓ corn, ⅓ barley, ⅓ wheat was added to 1.2 liters of water and heated to 70° C. The mixture was allowed to rest for 90 minutes and the liquid decanted from the resultant distiller's grains. 10 mL of distilled de-ionized water added to approximately 1 g maize (corn/barley/wheat mixture). Add 10 mL of Fortiva Revo* to each sample. 15 minute incubation at 25° C. at 500 rpm for each sample

10 minute centrifugation at 25° C. at 10,000 rpm for each sample

Decant supernatant (approximately 10 mL water). Membrane separation of the supernatant of 60 to 80 sieve maize remnants (0.177 to 0.250 mm—regular filter paper). Add one vial (10 mL volume) of resin to each sample**. Incubate each sample 15 minutes at 25° C. in ultrasound bath. Incubate each sample 15 minutes at 25° C. at 500 rpm. 10 minute centrifugation of each sample at 25° C. at 10,000 rpm. Resuspend each resin pellet in 5 mL (2 mL) 95% ethanol. Incubate each sample 15 minutes at 25° C. in ultrasound bath. Incubate each sample 15 minutes at 25° C. at 500 rpm. 10 minute centrifugation of each sample at 25° C. at 10,000 rpm. Decant the supernatant of each sample for gas chromatography/mass spectroscopy. Evaporate the sample down to approximately 250 microL and inject 1 microL into the gas chromatography/mass spectrometer for analysis. NIST (United States National Measurement Institute) mass spectral library search was used to identify the peak of the resultant mass spectrum and compared to known standards. No gas chromatography/mass spectroscopy results were found in the resultant supernatant. Liquid enzyme did not allow for the extraction of bioactive compounds from the sample.
Novozymes: Fortiva Revo. Liquid alpha-amylase and protease.
Resin: Amberlite XAD-7. CAS 37380-43-1 MDL Number: MFCD00132705 AAL 1956422 L1956422

### Example 3

310 g of number 60 sieve (0.250 mm) mixture of ⅓ corn, ⅓ barley, ⅓ wheat was added to 1.2 liters of water and heated to 70° C. The mixture was allowed to rest for 90 minutes and the liquid decanted from the resultant distiller's grains.

### Sample No. 1.

10 mL of 95% ethanol added to 1 g maize (corn/barley/wheat mixture). 15 minute incubation at 25° C. at 500 rpm. 10 minute centrifugation at 25° C. at 10,000 rpm. Decant supernatant and store at −20° C. for analysis with gas chromatography/mass spectroscopy (supernatant is the free/solute phenolics).

### Sample No. 2.

10 mL of 95% ethanol added to 1 g maize (corn/barley/wheat mixture). Add 25 mg (¼ vial) of lyophilized protease enzyme*. 15 minute incubation at 25° C. at 500 rpm. 10 minute centrifugation at 25° C. at 10,000 rpm. Decant supernatant and store at −20° C. for analysis with gas chromatography/mass spectroscopy.

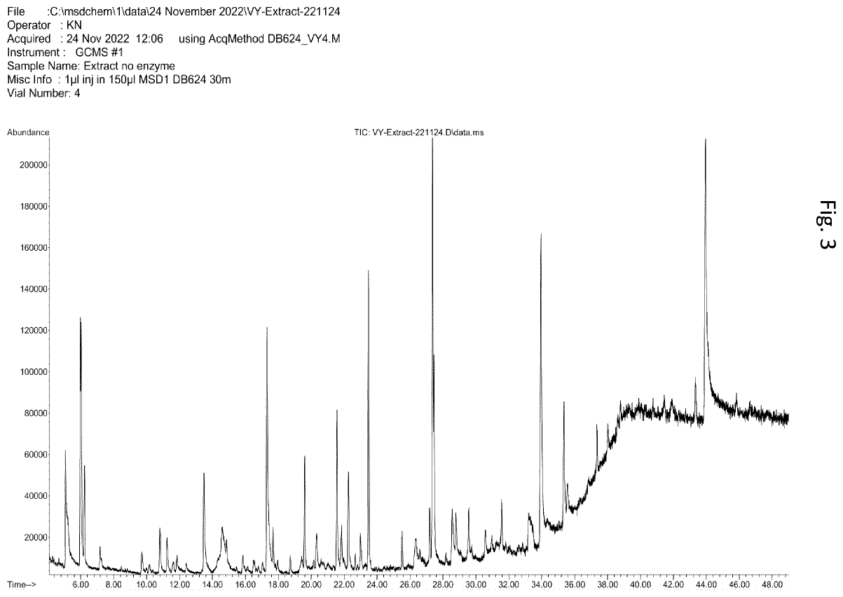

(supernatant is the free/solute and possibly lipophilic phenolics). Decant the supernatant of each sample for gas chromatography/mass spectroscopy. Evaporate the sample down to approximately 250 microL and inject 1 microL into the gas chromatography/mass spectrometer for analysis. NIST (United States National Measurement Institute) mass spectral library search was used to identify the peak of the resultant mass spectrum and compared to known standards. See GC/MS spectrogram FIGS. 3 (extract no enzyme) and 4 (extract with enzyme) respectively. Lyophilized enzyme (powdered) surprisingly and unexpectedly did not have added liquid contaminants or interfere with the extraction of bioactive compounds.
Millipore Sigma ALCALASE enzyme, Bacillus lichenformis. Catalogue #126741500 ML.

### REFERENCE NUMBERS

1 Stripping column
2 First centrifuge
3 Syrup evaporator
4 Thin stillage
5 Syrup
6 Ethanol
7 Lyophilized enzyme
8 Second centrifuge
9 Evaporator
10 Syrup
11 Ethanol
12 Dryer
13 Wet cake
14 Distillers' dry grains with solubles
15 Bioactive compounds
// Variable flow

While the claimed invention has been described in detail and with reference to specific embodiments thereof, it will be apparent to one of ordinary skill in the art that various changes and modifications can be made to the claimed invention without departing from the spirit and scope thereof.

1. A method of extracting bioactive compounds from ethanol brewers stillage comprising:
providing stillage from an ethanol plant, the stillage comprising spent grains suspended in water;
adding a lyophilized enzyme to the stillage;
adding ethanol to the stillage to form a mixture of ethanol and stillage;
mixing the mixture of ethanol and stillage;
extracting the ethanol from the mixture of ethanol and stillage to form a solution of bioactive compounds dissolved in extracted ethanol and spent grains containing the lyophilized enzyme; and
separating the bioactive compounds from the extracted ethanol by distillation or evaporation of the ethanol.

2. The method according to claim 1, further comprising separating the water from the stillage prior to adding the ethanol to the stillage.

3. The method according to claim 1, further comprising heating the mixture of ethanol and stillage.

4. The method according to claim 1, wherein the extracted ethanol removed from the bioactive compounds is added to the stillage.

5. The method according to claim 1, wherein the mixture of ethanol and stillage is mixed by centrifuging.

6. The method according to claim 1, further comprising heating the mixture of ethanol and stillage prior to extracting the ethanol.

7. The method according to claim 1, wherein the ethanol is extracted from the mixture of ethanol and stillage by centrifuging.

8. The method according to claim 1, wherein the bioactive compounds comprise a polyphenol.

9. The method according to claim 8, wherein the polyphenol comprises at least one selected from the group of cinnamic acid derivatives—ferulic acid and p-coumaric acid, Benzoic acid derivatives—caffeic acid, Anthocyanins—cyanidin-3-glucoside and delphinidin-3-glucoside, Flavones—tricin, and Lignans—secoisolariciresinol diglycoside.

10. The method according to claim 1, wherein the bioactive compounds comprise at least one of formic acid, propanol, propanone, propylene glycol, butanediol, furfural, furanmethanol, lactic acid, dihydroxyacetone, ethanol, oxirane, furancarboxylic acid, thiazole, maltol, furanone, pyranone, diglycerol, pentanoic acid, methylbutanoic anhydride, hydroxymethylfurfufral, benzenediol, succinic acid, tetraoxacyclododecanone, methylbutanoate, or benzoic acid.

11. The method according to claim 1, wherein the step of providing stillage further comprises brewing ethanol from grains suspended in the water to form the stillage and ethanol.
